(19) United States
(12) Patent Application Publication
(10) Pub. No.: US 2020/0157953 A1
(43) Pub. Date: May 21, 2020

(54) COMPOSITE FAN BLADE WITH ABRASIVE TIP

(71) Applicant: General Electric Company, Schenectady, NY (US)

(72) Inventors: Nitesh Jain, Bangalore (IN); David William Crall, Loveland, OH (US); Nicholas Joseph Kray, Mason, OH (US)

(21) Appl. No.: 16/196,288

(22) Filed: Nov. 20, 2018

(51) Int. Cl. F01D 5/28; F01D 11/12

(52) U.S. Cl. CPC F01D 5/288; F01D 5/282; F05D 2300/611; F05D 2240/307; F05D 2300/603; F01D 11/122

(57) ABSTRACT

A blade for a propulsion apparatus. The blade includes a body formed of a composite material and the body has opposed pressure and suction sides. The body extends in span between a root and a tip and extends in chord between a leading edge and a trailing edge. The body defines a body tip surface. A protective cover extends from near the tip of the blade toward the root of the blade along the leading edge and a trailing edge of the body. The protective cover defines a protective tip surface and an abrasive material is adhered to the protective tip surface.

### BACKGROUND OF THE INVENTION

This invention relates to turbofan blades. More specifically, it relates to fan blades made of laminated composite material (i.e., carbon fiber/epoxy) protected by metal protective elements (e.g. leading edge guard, tip cap).

A gas turbine engine includes a turbomachinery core having a high-pressure compressor, a combustor, and a high-pressure turbine in a serial flow relationship. The core is operable in a known manner to generate a primary flow of propulsive gas. A typical turbofan engine adds a low-pressure turbine driven by the core exhaust gases which in turn drives a fan rotor through a shaft to generate a bypass flow of propulsive gas. In the case of a high bypass engine this provides the majority of the total engine thrust.

The fan rotor includes a fan that includes an array of fan blades extending radially outward from a fan disk. The fan blades are positioned radially inward of a shroud and include tips that are configured to clear the shroud during normal operating conditions. Conventionally fan blades are made of laminated composite material and are protected by metal protective elements, such as a tip cap. Conventionally, the tip cap is formed of metal and does not cover the tip end surface.

Such blades have a tip which operates in close proximity to a casing. The casing includes an abradable material. In operation, if the tip should contact the abradable material (e.g. during an excursion/“rub”), the abradable material will “lose” the interaction, i.e. it will be abraded away so that the blade tip is not damaged.

Historically, these composite fan blades have been assembled with a definite radial tip clearance from the abradable material for the purpose of preventing damage. For best aerodynamic performance it is desirable to have the tip clearance as small as possible. It is known in the art to provide a blade tip with an abrasive material. The blades are then assembled to the casing with either no clearance or slight interference. They are then operated in an initial run-in procedure to wear away the abradable. Stated another way, the initial run-in procedure is operated to grind-in the blade tips. The initial run-in procedure results in the smallest possible operating clearance.

One problem with conventional composite material blades operated in this manner is that composite material is brittle and therefore the tips are fragile. The blades must be set such that force that is incurred during the initial run-in procedure does not fracture the blade tips. Therefore, tolerances achieved are not as close as they might otherwise be.

### BRIEF DESCRIPTION OF THE INVENTION

This problem is addressed by providing a composite blade having a tip that is protected by a leading edge guard and a tip cap. Both the leading edge guard and the tip cap have an abrasive material applied to their respective distal ends.

According to one aspect, a blade for a propulsion apparatus. The blade includes a body formed of a composite material and the body has opposed pressure and suction sides. The body extends in span between a root and a tip and extends in chord between a leading edge and a trailing edge. The body defines a body tip surface. A protective cover extends from near the tip of the blade toward the root of the blade along the leading edge and a trailing edge of the body. The protective cover defines a protective tip surface and an abrasive material is adhered to the protective tip surface.

According to another aspect, a propulsor configured for tight relative to the clearances. The propulsor includes a blade, and a shroud that includes an abradable portion. The blade also includes a body that has a body tip surface positioned near the abradable portion of the shroud. The blade includes a leading edge and a trailing edge. A leading edge protector extends along the body from near the body tip surface of the blade away from the shroud. A tip cap also extends along the body from near the body tip surface of the blade away from the shroud. The leading edge protector and the tip cap define an edge surface. An abrasive material is adhered to the edge surface.

According to yet another aspect, a gas turbine engine apparatus that includes a turbomachinery core. A fan is coupled in driven relationship with the turbomachinery core and the fan includes a plurality of blades positioned around a disk. Each blade of the fan includes an airfoil body that includes composite materials and has opposed pressure and suction sides. The airfoil body extends in span between a root and a tip and extends in chord between a leading edge and a trailing edge. The airfoil body defines a body tip surface and a protective cover extends from near the tip toward the root and the protective cover defines a protective tip surface. An abrasive material is adhered to the protective tip surface.

### BRIEF DESCRIPTION OF THE DRAWINGS

The invention may be best understood by reference to the following description taken in conjunction with the accompanying drawing figures in which:

FIG. 1 is a schematic cross-sectional view of a gas turbine engine;

FIG. 2 is an enlarged view of a portion of the gas turbine engine of FIG. 1, showing a fan blade and a portion of a fan hub and shroud;

FIG. 3 is a view of a portion of the fan blade and shroud of FIG. 2;

FIG. 4 is a perspective view of a tip portion of the fan blade of FIG. 4; and

FIG. 5 shows a cross-sectional view of a portion of the trailing edge of the fan blade taken along line 5-5 in FIG. 4 showing the relationship of a tip cap and the body of the fan blade; and

FIG. 6 shows a cross-sectional view of a portion of the leading edge of the fan blade taken along line 6-6 in FIG. 3 showing the relationship of a leading edge cover to the body of the fan blade.

### DETAILED DESCRIPTION OF THE INVENTION

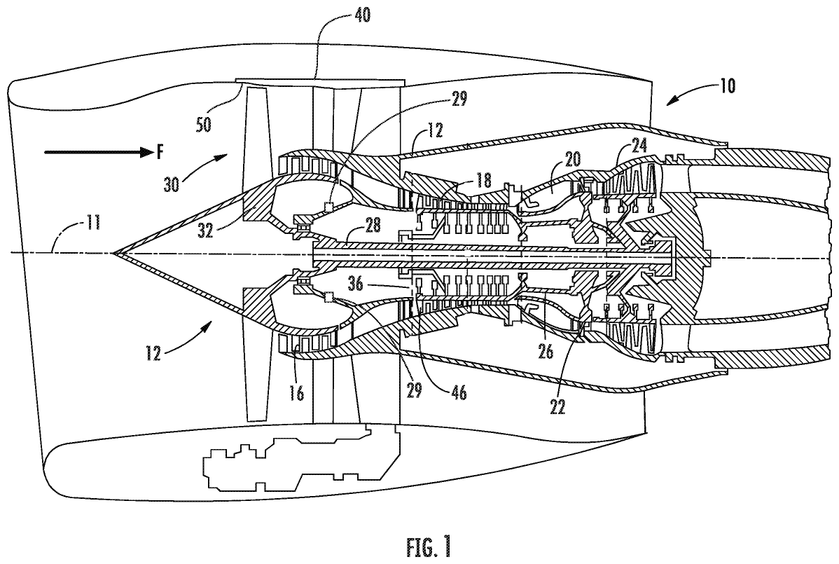

Referring to the drawings wherein identical reference numerals denote the same elements throughout the various views, FIG. 1 depicts an exemplary gas turbine engine 10 that includes a propulsion apparatus. While the illustrated example is a high-bypass turbofan engine, the principles of the present invention are also applicable to other types of engines, such as low-bypass turbofans, turbojets, turboprops, etc. The engine 10 has a longitudinal center line or axis 11. As used herein, the terms “axial” and “longitudinal” both refer to a direction parallel to the centerline axis 11, while “radial” refers to a direction perpendicular to the axial direction, and “tangential” or “circumferential” refers to a direction mutually perpendicular to the axial and radial directions. As used herein, the terms “forward” or “front” refer to a location relatively upstream in an air flow passing through or around a component, and the terms “aft” or “rear” refer to a location relatively downstream in an air flow passing through or around a component. The direction of this flow is shown by the arrow “F” in FIG. 1. These directional terms are used merely for convenience in description and do not require a particular orientation of the structures described thereby.

The engine 10 has a fan 12, booster 16, compressor 18, combustor 20, high pressure turbine or “HPT” 22, and low-pressure turbine or “LPT” 24 arranged in serial flow relationship. In operation, pressurized air from the compressor 18 is mixed with fuel in the combustor 20 and ignited, thereby generating combustion gases. Some work is extracted from these gases by the high-pressure turbine 22 which drives the compressor 18 via an outer shaft 26. The combustion gases then flow into the low-pressure turbine 24, which drives the fan 12 and booster 16 via an inner shaft 28.

The fan 12 is one example of a propulsion apparatus. It will be understood that the principles described herein are applicable to other kinds of propulsion apparatus operable to produce propulsive thrust, such as ducted propellers or compressors. Instead of a gas turbine engine, the fan 12 or other propulsion apparatus could be driven by another type of prime mover such as: heat engines, motors (e.g. electric, hydraulic, or pneumatic), or combinations thereof (for example electric hybrid drivetrains). The propulsion apparatus may be driven directly by a prime mover, or through an intermediate geartrain.

A plurality of mechanical fuses 29 are positioned mechanically between the fan 12 and the shaft 28. The mechanical fuses 29 are configured to transfer rotational energy from the shaft 28 during normal operation. High radial forces may cause a mechanical fuse 29 to fail thus allowing the fan 12 to rotate about a new axis of rotation. The mechanical fuse 29 is referred to as a load reduction device, or LRD.

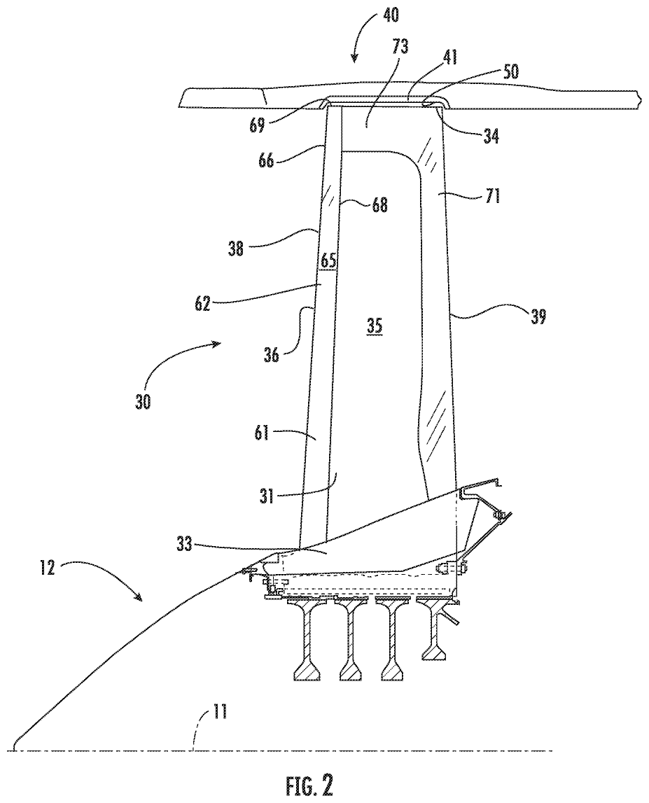

Referring now to FIG. 2, the fan 12 includes a plurality of fan blades 30. The fan blades 30 are mounted to a fan disk 32 (shown in FIG. 1) and each includes a body 31. Each fan blade extends from a root 33 to a tip 34 and has a pressure side 35, a suction side 36, a leading-edge 38 and a trailing edge 39.

A leading edge guard 61 is positioned such that the leading edge guard 61 defines the leading edge 38 of the blade 30 and covers a portion of the body 31 of the blade 30. The leading edge guard 61 has a nose 62 and a horseshoe-shaped cross-section as shown in FIG. 6. The leading edge guard 61 includes a pressure side wing 65 and a suction side wing 66. The pressure side wing 65 has a side edge 68 that is spaced away from the leading edge 38. The suction side wing 66 has a similar edge that is not shown. The leading edge guard 61 has a leading edge tip 69 that is positioned near the tip 34 of the blade 30. The leading edge guard 61 can be configured such that the leading edge tip 69 extends beyond the body 31 of the blade 30. Alternatively, the leading edge tip 69 can end even with the body 31 of the blade 30 or end short of the tip 34 of the body 31 of the blade 30 such that a portion of the body 31 of the blade 30 extends beyond the leading edge tip 69 of the leading edge guard 61. In this regard, the body 31 defines a body tip surface 37 that is not coplanar with the leading edge tip 69. In some embodiments, the body tip surface 37 is coplanar with the leading edge tip 69.

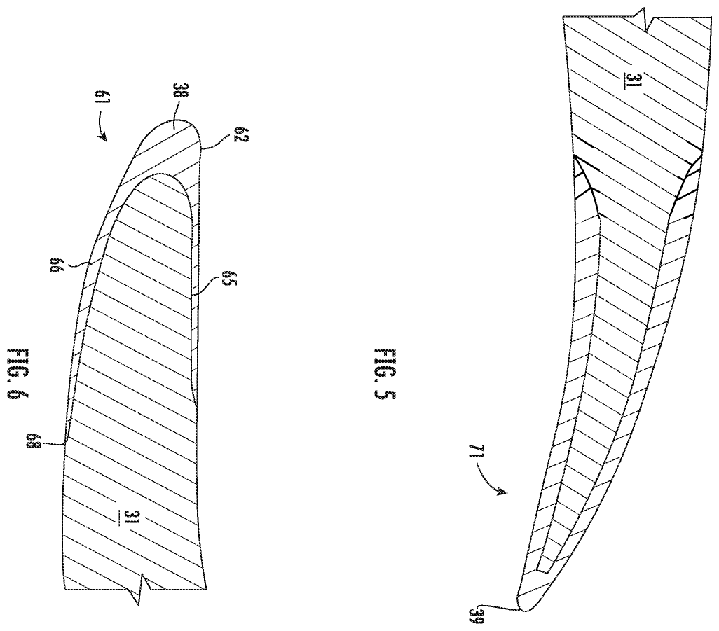

A tip cap 71 is positioned over a portion of the body 31 such that the tip cap 71 defines the trailing edge 39. The tip cap 71 is horseshoe-shaped as can be seen in FIG. 5. The tip cap 71 extends to a tip cap edge 79. In a region near the tip cap edge 79, the tip cap 71 extends forward from the trailing edge 39 toward the leading edge 38. In this manner, the tip cap 71 defines an upper limb 73. As can be seen in the illustrated embodiment, the upper limb 73 abuts the side edge 68 of the leading edge guard 61. The upper limb 73 can be spaced apart from the site edge 68 of the leading edge guard 61 in other embodiments.

To summarize, the exterior shape of the blade 30 is defined in part by the body 31 and in part by the leading edge guard 61 and the tip cap 71. The leading edge guard 61 and the tip cap 71 may be attached to the body 31 with a known type of adhesive. The leading edge guard 61 and the tip cap 71 are both protective covers.

The leading edge guard 61 and the tip cap 71 may be made from a metal alloy of a composition providing desired strength and weight characteristics. Non-limiting examples of suitable alloys for construction of the leading edge guard 61 include titanium alloys and nickel alloys.

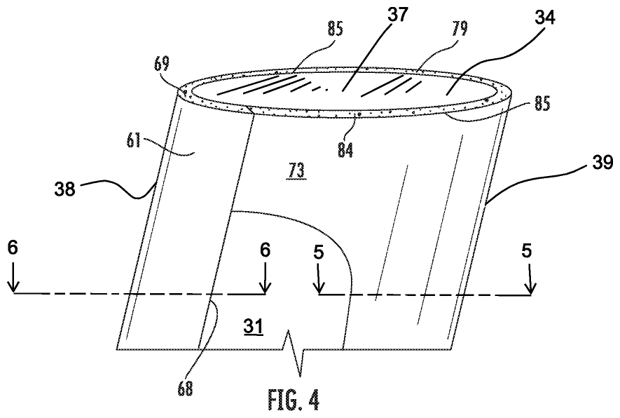

Referring now to FIG. 4, an abrasive material 85 is distributed along the tip cap edge 79 of the tip cap 71 and along the leading edge tip 69 of the leading edge guard 61. In this regard, the tip cap edge 79 and the leading edge tip 69 define a protective tip surface 84. The abrasive material 85 can be adhered to the surface 84 via a conventionally known adhesive and can be a particulate. For example, a particulate abrasive could be applied using an adhesive material. The specific abrasive, adhesive, in thickness of each can be determined based on conventional abrasive systems.

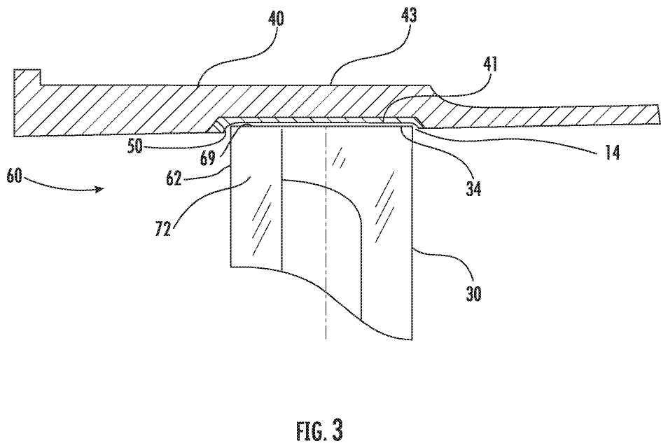

As shown in FIG. 3, the fan casing 40 includes an inner annular surface 50. The inner annular surface circular cross-section and defines an inner diameter of the fan casing 40. The inner annular surface 50 is configured to channel the incoming air through the fan 12 (FIG. 1) so as to ensure that the fan 12 (FIG. 1) will compress the bulk of the air entering the engine 10. By way of example and not limitation, the fan casing 40 can be made of the following: a metal, a composite material, and a combination thereof.

As shown in FIG. 3, the inner casing 40 includes a thin layer of shroud material 41 positioned adjacent to a blade tip path defined by the blades 30 of the fan 12. The shroud material 41 is abradable and is supported by a containment structure 43.

A small radial gap 14 is defined by a wear-in process, i.e. a grind in process, as described below such that the small radial gap 14 is present between the tips 34 of the fan blades 30 and the inner annular surface 50. It is this clearance, i.e., the radial gap 14, that is minimized in order to promote the efficiency of the engine 10.

The apparatus disclosed herein can be better understood by description of the operation thereof. Prior to regular use of the engine 10, the engine 10 is operated in a manner that allows the fan 12 to run in, i.e., grind in, such that the small radial gap 14 is defined. This regard, the shroud material 41 of the containment structure 43 is removed where the shroud material 41 intrudes into the intended gap 14. First, the engine 10 is operated. Second, the fan 12 rotates. Third, the abrasive material 85 on the respective tips 69 and 79 of the leading edge guard 61 and the tip cap 71 contacts the intruding shroud material 41. The intruding shroud material 41 is removed from the containment structure 43 leaving sufficient shroud material 41 to define the intended gap 14.

The advantage of a fan blade configured to abrade shroud material more aggressively than conventional blades is that closer tolerances can be defined between the blade and the shroud relative to conventional blades. In this regard the tip clearance can be minimized thus increasing engine efficiency.

In summary, the illustrated embodiment is a composite blade that includes a leading edge and a tip cap both of which define edges along the tip of the blade. These edges are configured to support an abrasive material and to provide strength to the blade such that contact between the tip edges and the abrasive material and a surrounding shroud material results in a predetermined wear-in of the shroud material.

The foregoing has described an apparatus, i.e., a fan blade that includes a tip region that is configured to provide sufficient operating strength and abrasive material for wearing in of close tolerances between the blade tips and surrounding shroud. For normal operating conditions, and to fail when a predetermined load is applied to the tip of the blade.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not limited to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A blade for a propulsion apparatus, comprising:
a body formed of a composite material having opposed pressure and suction sides, and extending in span between a root and a tip, and extending in chord between a leading edge and a trailing edge;
the body defining a body tip surface;
a protective cover extending from near the tip of the blade toward the root of the blade along the leading edge and the trailing edge of the body;
the protective cover defining a protective tip surface; and
wherein an abrasive material is adhered to the protective tip surface.

2. The blade of claim 1, wherein the body tip surface is substantially free of the abrasive material.

3. The blade of claim 2, wherein the protective cover includes a leading edge protector that defines a leading edge tip and the leading edge tip defines at least a portion of the protective tip surface.

4. The blade of claim 2, wherein the protective cover includes a tip cap that defines a tip cap edge and the tip cap edge defines at least a portion of the protective tip surface.

5. The blade of claim 2, wherein the protective cover includes a leading edge protector that defines a leading edge tip and a tip cap the defines a tip cap edge and together the leading edge tip and the tip cap edge define the protective tip surface.

6. The blade of claim 5, wherein the body tip surface defines a plane and the protective tip surface is substantially coplanar with the body tip surface.

7. The blade of claim 5, wherein the body tip surface defines a plane and the protective cover extends away from the root of the blade beyond the plane of the body tip surface.

8. The blade of claim 5, wherein the body tip surface defines a plane and the protective tip surface of the protective cover is positioned between the plane of the body tip surface and the root.

9. A gas turbine engine apparatus, comprising:
a turbomachinery core;
a fan coupled in driven relationship with the turbomachinery core, the fan including:
a plurality of blades positioned around a disk, each blade including:
an airfoil body comprising composite materials and having opposed pressure and suction sides, and extending in span between a root and a tip, and extending in chord between a leading edge and a trailing edge;
the airfoil body defining a body tip surface;
a protective cover extending from near the tip toward the root;
the protective cover defining a protective tip surface; and
wherein an abrasive material is adhered to the protective tip surface.

10. The apparatus of claim 9, wherein the body tip surface is substantially free of the abrasive material.

11. The apparatus of claim 10, wherein the protective cover includes a leading edge protector that defines a leading edge tip and the leading edge tip defines at least a portion of the protective tip surface.

12. The apparatus of claim 10, wherein the protective cover includes a tip cap that defines a tip cap edge and the tip cap edge defines at least a portion of the protective tip surface.

13. The apparatus of claim 10, wherein the protective cover includes a leading edge protector that defines a leading edge tip and a tip cap the defines a tip cap edge and together the leading edge tip and the tip cap edge define the protective tip surface.

14. The apparatus of claim 13, wherein the body tip surface defines a plane and the protective tip surface is substantially coplanar with the body tip surface.

15. The apparatus of claim 13, wherein the body tip surface defines a plane and the protective cover extends away from the root of the blade beyond the plane of the body tip surface.

16. The apparatus of claim 13, wherein the body tip surface defines a plane and the protective tip surface of the protective cover is positioned between the plane of the body tip surface and the root.

17. A propulsor configured for tight relative clearances, the propulsor comprising:
a blade;
a shroud that includes an abradable portion;
the blade including a body having a body tip surface positioned near the abradable portion of the shroud;
the blade including a leading edge and a trailing edge;
a leading edge protector extending along the body from near the body tip surface of the blade away from the shroud;
a tip cap extending along the body from near the body tip surface of the blade away from the shroud;
the leading edge protector and the tip cap define an edge surface; and
an adhesive material configured to abrade the abradable portion of the shroud is adhered to the edge surface.

18. A propulsor according to claim 17, wherein the body tip surface is substantially free of an abrasive material.

19. A propulsor according to claim 18 wherein the edge surface is substantially coplanar with the body tip surface.

20. A propulsor according to claim 18 wherein the edge surface is not coplanar with the body tip surface.
